(19) United States
(12) Patent Application Publication
(10) Pub. No.: US 2025/0045608 A1
(43) Pub. Date: Feb. 6, 2025

(54) AUTOMATIC DECOMPOSITION METHOD FOR MDP

(71) Applicant: International Business Machines Corporation, Armonk, NY (US)

(72) Inventors: Alexander Zadorojniy, Haifa (IL); Long Vu, Chappaqua, NY (US); Dharmashankar Subramanian, Rye Brook, NY (US)

(21) Appl. No.: 18/230,138

(22) Filed: Aug. 3, 2023

(51) Int. Cl. G06N 7/01; G06Q 10/04; G06Q 50/04

(52) U.S. Cl. CPC G06N 7/01; G06Q 10/04; G06Q 50/04

(57) ABSTRACT

A method for Markov Decision Process (“MDP”) decomposition includes receiving data elements for a problem that include finite state data for a set of state variables and a finite set of actions. A portion of the state data corresponding to state variables represents states. The method incudes creating two or more sub-MDPs. Each sub-MDP includes a portion of the set of state variables, the set of actions and a same reward function. The method includes executing each sub-MDP. Results include a policy and an expected reward from the reward function. The policy of the sub-MDP maps states of the sub-MDP to actions. The method includes aggregating, based on the expected rewards of the results, the actions of the policies of the sub-MDPs to create a resultant policy with resultant actions and generating, using state entries for the set of state variables, results to the problem based on the resultant policy.

### BACKGROUND

The subject matter disclosed herein relates to a Markov Decision Process (“MDP”) and more particularly relates to an automatic decomposition for an MDP.

A Markov Decision Process is a discrete-time stochastic control process that provides a mathematical framework for modeling decision making in situations where outcomes are partly random and partly under the control of a decision maker. MDPs are sometimes used for optimization problems solved with Linear Programming (LP) or dynamic programming. For an MDP, at each time step the process is in some state and a decision maker may choose an action that is available for the state. The MDP responds at the next time step by moving to a new state, and giving the decision maker a reward. Transition probabilities between the states are influenced by the chosen action. The next state depends on the current state and the decision maker's action, satisfying the Markov Property.

### SUMMARY

A computer-implemented method for MDP decomposition and aggregation is disclosed. An apparatus and computer program product also perform the functions of the apparatus. The computer-implemented method includes receiving data elements for a problem. The data elements include finite state data for a set of state variables and a finite set of actions. A portion of the state data corresponding to each of the set of state variables represents a state. The problem is to be formulated using a Markov Decision Process (“MDP”). The method incudes creating two or more sub-MDPs. Each sub-MDP includes a portion of the set of state variables and the set of actions. Each sub-MDP includes less than the set of state variables in an MDP with a complete set of the set of state variables. Each sub-MDP includes a same reward function. The method includes executing, using at least one processor, each sub-MDP. Results of execution of a sub-MDP of the two or more sub-MDPs includes a policy and an expected reward from the reward function. The policy of the sub-MDP maps states of the sub-MDP to actions. The method includes aggregating, based on the expected rewards of the results, the actions of the policies of the sub-MDPs to create a resultant policy with a set of resultant actions and generating, using at least one processor and using state entries for the set of state variables, results to the problem based on the resultant policy.

An apparatus for MDP decomposition and aggregation includes at least one processor and non-transitory computer readable storage media storing code. The code is executable by the processor to perform operations that include receiving data elements for a problem. The data elements include a finite set of state variables and a finite set of actions. Each state variable of the set of state variables includes state entries. Each state entry represents a state and the problem is to be formulated using a Markov Decision Process. The operations include creating two or more sub-MDPs. Each sub-MDP includes a portion of the set of state variables and the set of actions. Each sub-MDP includes less than the set of state variables in an MDP with a complete set of the set of state variables. Each sub-MDP comprises a same reward function. The operations include executing, using at least one processor, each sub-MDP. Results of execution of a sub-MDP of the two or more sub-MDPs include a policy and an expected reward from the reward function. The policy of the sub-MDP maps states of the sub-MDP to actions. The operations include aggregating, based on the expected rewards of the results, the actions of the policies of the sub-MDPs to create a resultant policy comprising a set of resultant actions, and generating, using at least one processor and using state entries for the set of state variables, results to the problem based on the resultant policy.

A computer program product for MDP decomposition and aggregation includes a computer readable storage medium having program instructions embodied therewith. The program instructions are executable by a processor to cause the processor to perform operations that include receiving data elements for a problem. The data elements include a finite set of state variables and a finite set of actions. Each state variable of the set of state variables includes state entries. Each state entry represents a state. The problem is to be formulated using a Markov Decision Process. The method incudes creating two or more sub-MDPs. Each sub-MDP includes a portion of the set of state variables and the set of actions. Each sub-MDP includes less than the set of state variables in an MDP with a complete set of the set of state variables. Each sub-MDP includes a same reward function. The method includes executing, using at least one processor, each sub-MDP. Results of execution of a sub-MDP of the two or more sub-MDPs includes a policy and an expected reward from the reward function. The policy of the sub-MDP maps states of the sub-MDP to actions. The method includes aggregating, based on the expected rewards of the results, the actions of the policies of the sub-MDPs to create a resultant policy with a set of resultant actions and generating, using at least one processor and using state entries for the set of state variables, results to the problem based on the resultant policy.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for MDP decomposition and aggregation, in accordance with various embodiments;

FIG. 2 is a schematic block diagram illustrating an apparatus for MDP decomposition and aggregation, in accordance with various embodiments;

FIG. 3 is a schematic block diagram illustrating another apparatus for MDP decomposition and aggregation, in accordance with various embodiments;

FIG. 4 is a diagram of a simple MDP with four state variables and three actions, according to various embodiments;

FIG. 5A is a schematic block diagram of an example manufacturing process with M stages before reaching retail, according to various embodiments;

FIG. 5B is a table with simulation results for the manufacturing process of FIG. 5A for different algorithms, including MDPs of different sizes, according to various embodiments;

FIG. 6A is a diagram depicting portions of an example of MDP decomposition and aggregation, according to various embodiments;

FIG. 6B is a schematic block diagram depicting data flow for portions of the example of MDP decomposition and aggregation of FIG. 6A, according to various embodiments;

FIG. 6C is a diagram depicting portions of an example of MDP decomposition and aggregation, according to various embodiments;

FIG. 7 is a schematic flow chart diagram illustrating one embodiment of a method for MDP decomposition and aggregation, according to various embodiments;

FIG. 8 is a schematic flow chart diagram illustrating one embodiment of another method for MDP decomposition and aggregation, according to various embodiments; and

FIG. 9 is a schematic block diagram of a computing environment for execution of MDP decomposition and aggregation.

### DETAILED DESCRIPTION OF THE INVENTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to” unless expressly specified otherwise. An enumerated listing of items does not imply that any or all of the items are mutually exclusive and/or mutually inclusive, unless expressly specified otherwise. The terms “a,” “an.” and “the” also refer to “one or more” unless expressly specified otherwise.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Code for carrying out operations for embodiments may be written in any combination of one or more programming languages including an object oriented programming language such as Python, Ruby, R. Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements.

Various aspects of the present disclosure are described by narrative text, flowcharts, block diagrams of computer systems and/or block diagrams of the machine logic included in computer program product (“CPP”) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (“RAM”), read-only memory (“ROM”), erasable programmable read-only memory (“EPROM” or “Flash memory”), static random access memory (“SRAM”), compact disc read-only memory (“CD-ROM”), digital versatile disk (“DVD”), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C.” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

A computer-implemented method for MDP decomposition and aggregation is disclosed. An apparatus and computer program product also perform the functions of the apparatus. The computer-implemented method includes receiving data elements for a problem. The data elements include a finite set of state variables and a finite set of actions. Each state variable of the set of state variables includes state entries. Each state entry represents a state. The problem is to be formulated using a Markov Decision Process (“MDP”). The method incudes creating two or more sub-MDPs. Each sub-MDP includes a portion of the set of state variables and the set of actions. Each sub-MDP includes less than the set of state variables in an MDP with a complete set of the set of state variables. Each sub-MDP includes a same reward function. The method includes executing, using at least one processor, each sub-MDP. Results of execution of a sub-MDP of the two or more sub-MDPs includes a policy and an expected reward from the reward function. The policy of the sub-MDP maps states of the sub-MDP to actions. The method includes aggregating, based on the expected rewards of the results, the actions of the policies of the sub-MDPs to create a resultant policy with a set of resultant actions and generating, using at least one processor and using state entries for the set of state variables, results to the problem based on the resultant policy.

In some embodiments, aggregating the policies of the sub-MDPs includes averaging at least a portion of the policies of two or more of the two or more sub-MDPs, and/or using majority voting for at least a portion of the actions of the policies of the two or more sub-MDPs. In other embodiments, aggregating the actions of the sub-MDPs includes determining that the expected reward of a sub-MDP of the two or more sub-MDPs is an outlier with respect to the expected rewards of other sub-MDPs of the two or more sub-MDPs, and excluding the sub-MDP with the expected reward determined to be an outlier from aggregation of the actions of the sub-MDPs. In other embodiments, the method includes ordering the state variables of the set of state variables prior to creating the two or more sub-MDPs according to a state importance criteria.

In some embodiments, a combination of the set of state variables of each of the two or more sub-MDPs equals the state variables of the set of state variables of the data elements. In other embodiments, each sub-MDP includes a transition probabilities matrix determining transition probabilities between states of the sub-MDP once actions of the set of actions of the sub-MDP are performed. In other embodiments, the expected reward of a sub-MDP of the two or more sub-MDPs is determined for a pair of a state of the sub-MDP and an action of the set of actions of the sub-MDP.

In some embodiments, the computer-implemented includes determining a binning strategy for each state variable and each action. A binning strategy for a state variable includes constraining the state variable to one of a limited number of possible values and a binning strategy for an action includes constraining the action to one of a limited number of possible values. In other embodiments, the problem includes a controls process with a controller where the resultant set of actions is implemented in the controller, a manufacturing process that includes optimization of the manufacturing process, and/or a queueing system.

An apparatus for MDP decomposition and aggregation includes at least one processor and non-transitory computer readable storage media storing code. The code is executable by the processor to perform operations that include receiving data elements for a problem. The data elements include a finite set of state variables and a finite set of actions. Each state variable of the set of state variables includes state entries. Each state entry represents a state and the problem is to be formulated using a Markov Decision Process. The operations include creating two or more sub-MDPs. Each sub-MDP includes a portion of the set of state variables and the set of actions. Each sub-MDP includes less than the set of state variables in an MDP with a complete set of the set of state variables. Each sub-MDP comprises a same reward function. The operations include executing, using at least one processor, each sub-MDP. Results of execution of a sub-MDP of the two or more sub-MDPs include a policy and an expected reward from the reward function. The policy of the sub-MDP maps states of the sub-MDP to actions. The operations include aggregating, based on the expected rewards of the results, the actions of the policies of the sub-MDPs to create a resultant policy comprising a set of resultant actions, and generating, using at least one processor and using state entries for the set of state variables, results to the problem based on the resultant policy.

In some embodiments, aggregating the policies of the sub-MDPs includes averaging at least a portion of the policies of two or more of the two or more sub-MDPs, and/or using majority voting for at least a portion of the actions of the policies of the two or more sub-MDPs. In other embodiments, aggregating the actions of the sub-MDPs includes determining that the expected reward of a sub-MDP of the two or more sub-MDPs is an outlier with respect to the expected rewards of other sub-MDPs of the two or more sub-MDPs, and excluding the sub-MDP with the expected reward determined to be an outlier from aggregation of the actions of the sub-MDPs. In other embodiments, the operations include ordering the state variables of the set of state variables prior to creating the two or more sub-MDPs according to a state importance criteria.

In some embodiments, a combination of the set of state variables of each of the two or more sub-MDPs equals the state variables of the set of state variables of the data elements. In other embodiments, each sub-MDP includes a transition probabilities matrix determining transition probabilities between states of the sub-MDP once actions of the set of actions of the sub-MDP are performed. In other embodiments, the expected reward of a sub-MDP of the two or more sub-MDPs is determined for a pair of a state of the sub-MDP and an action of the set of actions of the sub-MDP. In other embodiments, the computer-implemented method includes determining a binning strategy for each state variable and each action. A binning strategy for a state variable includes constraining the state variable to one of a limited number of possible values and a binning strategy for an action includes constraining the action to one of a limited number of possible values. In other embodiments, the problem includes a controls process with a controller where the resultant set of actions is implemented in the controller, a manufacturing process with optimization of the manufacturing process, and/or a queueing system.

A computer program product for MDP decomposition and aggregation includes a computer readable storage medium having program instructions embodied therewith. The program instructions are executable by a processor to cause the processor to perform operations that include receiving data elements for a problem. The data elements include a finite set of state variables and a finite set of actions. Each state variable of the set of state variables includes state entries. Each state entry represents a state. The problem is to be formulated using a Markov Decision Process. The method incudes creating two or more sub-MDPs. Each sub-MDP includes a portion of the set of state variables and the set of actions. Each sub-MDP includes less than the set of state variables in an MDP with a complete set of the set of state variables. Each sub-MDP includes a same reward function. The method includes executing, using at least one processor, each sub-MDP. Results of execution of a sub-MDP of the two or more sub-MDPs includes a policy and an expected reward from the reward function. The policy of the sub-MDP maps states of the sub-MDP to actions. The method includes aggregating, based on the expected rewards of the results, the actions of the policies of the sub-MDPs to create a resultant policy with a set of resultant actions and generating, using at least one processor and using state entries for the set of state variables, results to the problem based on the resultant policy.

In some embodiments, aggregating the policies of the sub-MDPs includes averaging at least a portion of the policies of two or more of the two or more sub-MDPs, and/or using majority voting for at least a portion of the actions of the policies of the two or more sub-MDPs.

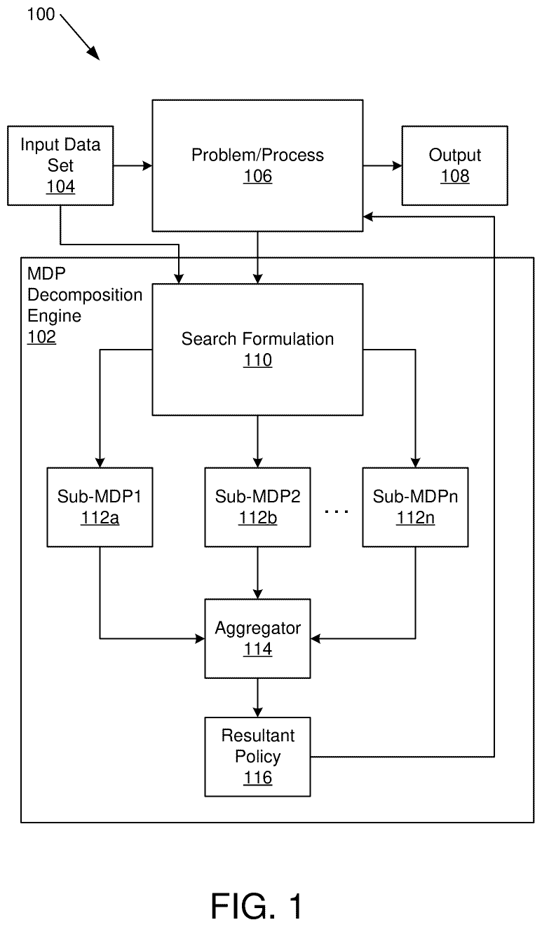

FIG. 1 is a schematic block diagram illustrating a system 100 for MDP decomposition and aggregation, in accordance with various embodiments. The system 100 includes a Markov Decision Process (“MDP”) decomposition engine 102 described below. The system 100 includes an input data set 104 that is input to a problem/process 106, which produces an output 108. The problem/process 106 is any problem or process that can be formulated into an MDP. Complicated problems/processes 106 often result in a very large number of states and associated actions, which become very computationally intense. Some MDPs formulated for a complicated or large problem or process may take hours or days or even more. Classical MDP has a “curse of dimensionality” issue. Often state sizes are limited to around 10,000 states with 100 actions. Larger MDPs often take too long to process and require enormous computing resources. The MDP decomposition engine 102 breaks a formulation with a large number of states into smaller sub-MDPs that are computationally easier to handle and then uses aggregation to combine actions of resulting policies of the sub-MDPs to generate a resultant policy that may be applied to the problem/process 106. The input data set 104 may then be applied to the problem/process 106 to create an output 108 that is more efficient, better, etc. than would be achieved without MDP.

A Markov Decision Process is typically formulated as 4-tuple of (S. A, Pₐ, Rₐ). S is a set of states called a state space. A is a set of actions called an action space, or alternatively, Aₛ is the set of actions available from state s. Pₐ (s, s′)=Pr (s₁₊₁=s′|sₜ=s, aₜ=a) is the probability that an action a in state s at time t will lead to state s′ at time t+1. Rₐ (s, s′) is the intermediate reward (or expected immediate reward) received after transitioning from state s to s′, due to action a. In general, the state and action spaces may be finite or infinite, for example the set of all real numbers. The MDP decomposition engine 102 is applicable to a finite set of states and a finite set of actions. Executing an MDP results in creation of a policy π, which is a mapping from the state space (S) to the action space (A).

The goal of a Markov decision process is to find a good ‘policy’ for a decision maker and a function π that specifies an action π(s) that the decision maker will choose when in state s. Once the MDP is combined with a policy in this way, the actions are fixed for each state and the resulting combination behaves like a Markov chain because the action chosen in state s is determined by π(s) and Pr (sₜ₊₁=s′|sₜ=s, aₜ=a) reduces to Pr_π(sₜ₊₁=s′|sₜ=s), which is a Markov transition matrix.

The objective of using MDP is to choose a policy π that will maximize a cumulative function of the random rewards or will minimize an expected cost, which is typically the expected discounted sum over a potentially infinite horizon:

$$E [ {\sum }_{t = 0}^{∞} {γ}^{t} {R}_{{a}_{t}} ( {s}_{t} , {s}_{t + 1} ) ] \qquad ( 1 )$$

(where aₜ=π(sₜ), i.e., actions given by the policy). The expectation is taken over policy πsₜ₊₁˜P_{a_t} (sₜ, sₜ₊₁) where γ is the discount factor satisfying 0≤γ≤1, which is usually close to 1 (for example, γ=1/(1+r) for some discount rate r). Typically, a lower discount factor provides motivation to the decision maker to favor taking actions early, rather than postpone the actions indefinitely. A policy that optimizes equation 1 is called an optimal policy and is usually denoted as π*. A particular MDP may have multiple distinct optimal policies.

Solutions for MDPs with a finite state space and a finite action space may be found through several methods, such as linear programming, dynamic programming, and the like. These algorithms apply to MDPs with finite state and action spaces and explicitly given transition probabilities and reward functions. The algorithm returns a policy x, that maps states to actions, and optimizing an objective function (e.g., maximizing an expected reward and/or minimizing an expected cost).

In some embodiments, the state and action spaces are constrained according to a binning strategy where the states and actions are limited to a common number of values, such as two values, three values, four values, five values, etc. For example, where the states and/or actions are limited to two values, the binning may constrain the states and actions to two values; 0 or 1, low and high, or something similar. In other embodiments, the binning strategy may allow 5 values. A state that is a voltage between 0 and 10 volts (“V”) may be digitized and constrained to be one or five values. 0-2 V may be constrained to be 1 V. 2-4 V may be constrained to be 3 V, 4-6 V may be constrained to be 5 V, etc. In the embodiments, digital outputs may also be formulated to have five possible values. One of skill in the art will recognize other binning strategies to constrain the state and action spaces to have a certain number of possible values.

The MDP decomposition engine 102 divides the total number of state variables S into R sets of |V|=K state variables. As used herein a full set of states and a full set of state variables are both denoted using “S.” The MDP decomposition engine 102 uses each set of |V| state variables to create R sub-MDPs instead of one large MDP with S state variables. Each sub-MDP includes the set of actions from the data set that would be in an MDP of the entire data set. Each sub-MDP includes the same reward function that produces an expected reward and/or an expected cost, which in some embodiments, is the reciprocal of the expected reward or something similar.

The MDP decomposition engine 102 executes each sub-MDP, which produce a policy and an expected reward from the reward function. The policy of the sub-MDP maps states of the sub-MDP to the actions. The MDP decomposition engine 102 aggregates, based on the expected rewards of the results, the actions of the policies of the sub-MDPs to create a resultant policy 116 that includes a set of resultant actions. The resultant policy 116 is then used by the problem/process 106 along with the input data set 104 to produce and output 108. The MDP decomposition engine 102 generates, using state entries for the set of state variables, results to the problem based on the resultant policy 116. The MDP decomposition engine 102 advantageously provides a solution for large problems/processes 106 that are computationally difficult and take a lot of computing resources where the MDP decomposition engine 102 provides an acceptable solution using a fraction of the time and computational resources of a full MDP with all states S.

The input data set 104, in some embodiments, includes states S from operation of a problem/process 106 along with actions associated with each state s. In some embodiments, the states are initially continuous but are transformed to discrete values prior to being input in the MDP decomposition engine 102. In other embodiments, state data is received from a problem/process 106 and transformed to discrete data in bins before being input to the MDP decomposition engine 102. One of skill in the art will recognize other formats for the input data set 104 and ways to prepare the input data set 104 for use by the MDP decomposition engine 102.

The output 108 of the problem/process 106, in some embodiments, is in the form of desired results of a problem, such as inventory of a supply chain problem, an optimized solution, etc. where the resulting policy from the MDP decomposition engine 102 is used to make selections, control steps, and the like of the problem. In other embodiments where the problem/process 106 is an industrial process, the output 108 is control of the industrial process where the resulting policy is used to define control parameters for one or more controllers of the industrial process. One of skill in the art will recognize forms of an output 108 of a problem/process 106 influenced by a resulting policy from a MDP decomposition engine 102.

In some embodiments, the MDP decomposition engine 102 includes a search formulation 110 that receives the input data set 104 and control parameters from the problem/process 106 to formulate arrays and matrices in an MDP format useful for formulating sub-MDPs. In some embodiments, the search formulation 110 formats actions from control rules, parameters, limits, controller outputs and the like. In some embodiments, the search formulation 110 creates actions that are dependent on one or more states. In some embodiments, the search formulation 110 creates matrices, arrays, etc. formulated for MDP without forming a full MDP.

In some embodiments, the search formulation 110 creates R sub-MDPs 112a-112n (collectively or generically “112”) from the input data set 104 and information from the problem/process 106. In some embodiments, the search formulation 110 creates bins for each state s in the state space S and each action a in the action space A. In some examples, the search formulation 110 divides possible values of a state or action into divisions, called bins where the bins of a state or action span an entire range of possible state/action values. In some examples, a state variable may have a range of 0 to 5 V and the search formulation 110 divides a range of 0 to 5 volts into 5 bins of 0-1 V. 1-2 V. 2-3 V. 3-4 V. and 4-5 V. Binning is described in more detail below with regard to the binning module 310.

In some embodiments, the search formulation 110 divides the state space S into R divisions of K states for R sub-MDPs 112. In some embodiments, the search formulation 110 includes all states of the state space S. In other embodiments, the search formulation 110 includes a subset of the states s of the state space S. In some embodiments, the search formulation 110 divides the state space S randomly. In other embodiment, the search formulation 110 divides the state space S based on a criteria. In some embodiments, the search formulation 110 orders the states s by importance using a state importance criteria prior to creation of the sub-MDPs 112.

In some embodiments, the search formulation 110 creates, for each sub-MDP 112, a transition probabilities matrix determining transition probabilities between states of the sub-MDP 112 once actions of the set of actions of the sub-MDP 112 are performed. In some embodiments, the search formulation 110 creates a reward function used for each sub-MDP 112 so that execution of the sub-MDPs 112 result in an expected reward that can be compared to each other.

In some embodiments, the search formulation 110 uses linear programming (“LP”) to formulate the sub-MDPs 112. In other embodiments, the search formulation 110 uses dynamic programming. In other embodiments, the search formulation 110 uses other algorithms for finite state and action spaces known to those of skill in the art.

In some embodiments, the MDP decomposition engine 102 includes an aggregator 114 that produces a resultant policy 116 that is then used by the problem/process 106 to produce an output 108. In some embodiments, the aggregator 114 combines actions of the policies of each of the sub-MDP as necessary. In some examples, some actions are identical so that combination is trivial. In other examples, actions differ and are combined using a combination technique, such as majority voting or averaging. In some embodiments, the aggregator 114 identifies a sub-MDP 112 that is an outlier in terms of expected rewards and excludes the outlier sub-MDP during aggregation of actions. In the embodiments, the aggregator 114 uses the remaining sub-MDPs 112 for aggregation.

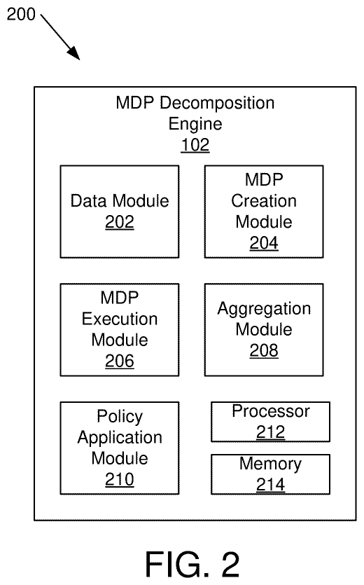

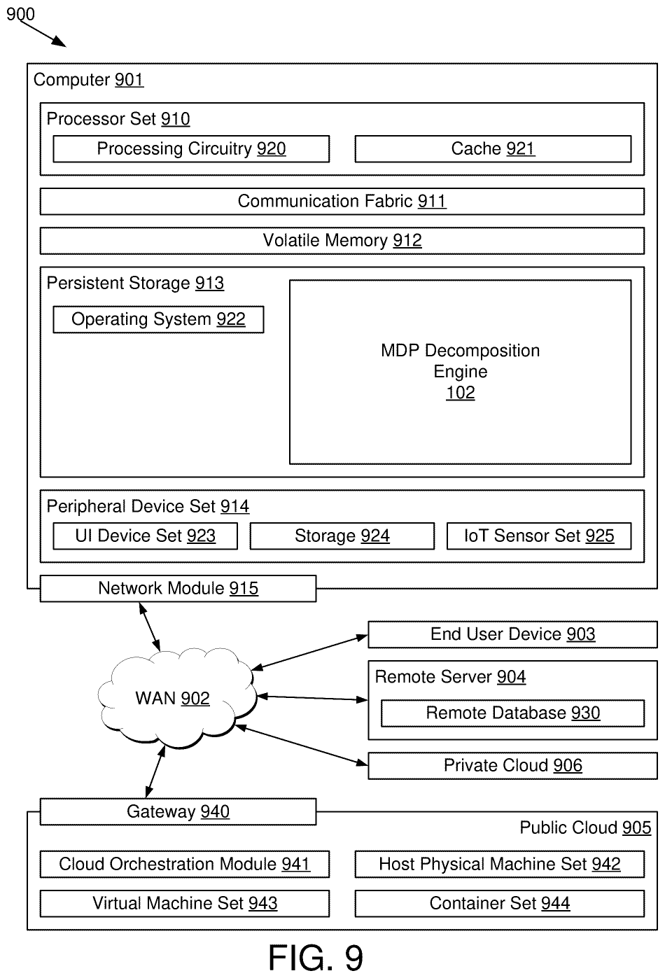

FIG. 2 is a schematic block diagram illustrating an apparatus 200 for MDP decomposition and aggregation, in accordance with various embodiments. The apparatus 200 includes an MDP decomposition engine 102 with a data module 202, an MDP creation module 204, an MDP execution module 206, an aggregation module 208, a policy application module 210, a processor 212, and memory 214, which are described below. In some embodiments, the apparatus 200 is implemented using a single computing device. In other embodiments, the apparatus 200 is implemented using multiple computing devices. In some embodiments, the modules 202-210 are stored on non-volatile computer readable storage media, which is non-transitory. In other embodiments, all or portions of the modules 202-210 are loaded into memory 214 for execution by the processor 212. Operation of the MDP decomposition engine 102 as applied to the apparatus 200 is described in more detail with regard to the computing environment 900 of FIG. 9.

The apparatus 200 includes a data module 202 configured to receive data elements for a problem/process 106. In some embodiments, the data module 202 is included in the search formulation 110. The data elements include a finite set of state variables S and a finite set of actions A. Each state variable of the set of state variables includes state entries. Each state entry representing a state s. In some embodiments, the data elements are part of the input data set 104, as described above. The problem/process 106 is to be formulated using a Markov Decision Process (“MDP”).

In some embodiments, the data module 202 receives the data elements from a problem/process 106. In some examples, the data elements are data collected from execution of the problem/process 106, for example, during a training phase. In other embodiments, the data elements are collected over time from the problem/process 106 prior to an attempt to improve the problem/process 106 using the MDP decomposition engine 102. In other embodiments, the data module 202 collects the data elements from a problem/process 106, such as an industrial process, that produces data on a continual basis. In some embodiments, the data elements are historical data from the industrial process. In other embodiments, the data elements are collected on a continuous basis, where data is sampled, or on a periodic basis. One of skill in the art will recognize other ways for the data module 202 to receive data elements for an MDP.

The apparatus 200 includes an MDP creation module 204 configured to creating two or more sub-MDPs 112a-n. In some embodiments, the MDP creation module 204 is included in the search formulation 110. Each sub-MDP 112 includes a portion of the set of state variables S and the set of actions A. Each sub-MDP 112 includes less than the set of state variables S, as discussed above with reference to the system 100 of FIG. 1, and the set of actions A in an MDP of a complete set of the set of state variables and the set of actions A. Each sub-MDP 112 includes a same reward function.

In some embodiments, the MDP creation module 204 divides the set of states S randomly. For example, where there are 1000 state variables S, the MDP creation module 204 may divide the 1000 state variables by an R of 5 to create subsets of K=200 state variables and may merely divide a matrix with 1000 columns into 5 smaller matrices of columns 1-200, 201-400, etc. In other embodiments, the MDP creation module 204 uses a criteria for dividing the states. In one embodiment, the MDP creation module 204 uses a state importance criteria or some other criteria. Once the states are divided, the MDP creation module 204 uses a common set of actions, a common reward criteria, and a transition probabilities matrix to create each sub-MDP 112. The transition probabilities matrix for a sub-MDP 112 determines transition probabilities between state variables of the set of states of the sub-MDP 112 once actions of the set of actions of the sub-MDP 112 are performed.

The apparatus 200 includes an MDP execution module 206 configured to execute, using at least one processor 212, each sub-MDP 112. Results of execution of a sub-MDP (e.g., 112a) of the two or more sub-MDPs 112a-n includes a policy and an expected reward from the reward function. The policy of the sub-MDP 112a maps states of the sub-MDP 112 to the actions. In one embodiment, the MDP execution module 206 executes each of the two or more sub-MDPs 112a-n sequentially. In other embodiments, the MDP execution module 206 executes the two or more sub-MDPs 112a-n in parallel. Beneficially, execution of the two or more sub-MDPs 112 is typically much faster than execution of a single MDP with all of the state variables S so that the MDP decomposition engine 102 is useful for situations where the state variables S would yield a very large MDP.

The apparatus 200, in some embodiments, includes an aggregation module 208 configured to aggregate, based on the expected rewards of the results, the actions of the sub-MDPs 112 to create a resultant policy 116 that includes a set of resultant actions. In some embodiments, the aggregator 114 incudes the aggregation module 208. Aggregation of the actions of the sub-MDPs 112 is a combining of like actions of the sub-MDPs 112 to create a resultant action that, in some instances, provides an improved resultant policy 116. In some embodiments, the aggregation module 208 aggregates actions by majority voting. For example, if action a_1 from sub-MDP 1 112a is 1, action a_1 from sub-MDP 2 112b is 0, and action a_1 from sub-MDP 3 112c is 1, majority voting would result in a resultant action a_1 of 1.

In some embodiments, other actions from the policies of the sub-MDPs 112 may not need to be combined. For example, where action a_2 is 1 for all of the sub-MDPs 112 being aggregated, no aggregation is necessary and resultant action a_2 remains at 1. In other embodiments, some actions of the sub-MDPs 112 may not be involved in a policy, and therefore are not part of the resultant policy 116.

In other embodiments, the aggregation module 208 averages actions of the policies of the sub-MDPs 112 to create a resultant policy 116. For example, action a_3 of sub-MDP 1 112a may be 3 and action a_3 of sub-MDP 2 112b may be 5 so that averaging the two creates a resultant action a_3 with a value of 4 of a resultant policy 116. Averaging versus majority voting may depend on binning of an action. In other embodiments, a sub-MDP (e.g., 112c) may be deemed an outlier and may not be included by the aggregation module 208, which may affect whether or not to average or to use majority voting. In other embodiments, the aggregation module 208 may use another aggregation technique. One of skill in the art will recognize other ways to aggregate actions of the policy of the sub-MDPs 112.

The apparatus 200 includes a policy application module 210 configured to generate, using at least one processor 212 and using state entries for the set of state variables S, results to the problem/process 106 based on the resultant policy 116. In some embodiments, the policy application module 210 uses new state entries in the state variables S in the problem/process 106 and the resultant policy to rerun the problem/process 106 to get a new output 108. In other embodiments, the policy application module 210 uses state entries from the input data set 104 and the resultant policy 116 to rerun the problem/process 106 to update the output 108.

The policy application module 210, in some embodiments, modifies actions of the problem/process 106 with the resultant policy 116. Beneficially, the problem/process 106 uses the resultant policy 116 to produce a better, more optimal, etc. output 108. In other embodiments, the policy application module 210 has a connection to the problem/process 106 to receive and implement the resultant policy 116. In other embodiments, the policy application module 210 facilitates user input to assist in implementing the resultant policy 116 in the problem/process 106. One of skill in the art will recognize other ways for the policy application module 210 to generate and use the resultant policy 116.

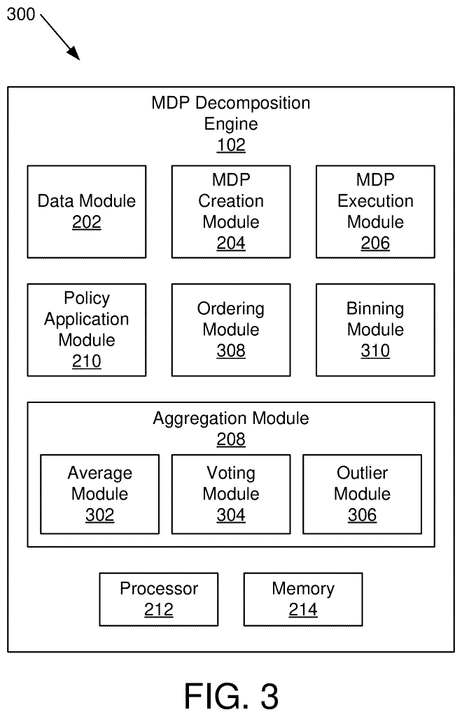

FIG. 3 is a schematic block diagram illustrating another apparatus 300 for MDP decomposition and aggregation, in accordance with various embodiments. The apparatus 300 includes an MDP decomposition engine 102 with a data module 202, an MDP creation module 204, an MDP execution module 206, an aggregation module 208, a policy application module 210, a processor 212, and memory 214, which are substantially similar to those described above in relation to the apparatus 200 of FIG. 2. The apparatus 300 includes an aggregation module 208 with an average module 302, a voting module 304, and an outlier module 306, an ordering module 308, and/or a binning module 310, which are described below. In various embodiments, the apparatus 300 is implemented similar to the apparatus 200 of FIG. 2.

In some embodiments, the apparatus 300 includes an aggregation module 208 with an average module 302 configured to average at least a portion of the policies of two or more of the two or more sub-MDPs 112. The average module 302 averages the values of two or more actions to derive a resulting action of a resultant policy 116. In some embodiments, the average module 302 averages values of an action, which results in a number that differs from an allowable value of a binned action. For example, an average action value may be 3.85, which would fall in a bin from 3.5 to 4.5 so that the average module 302 uses a resultant action value of 4, that fits in a binning strategy. In various embodiments, the average module 302 averages all applicable actions of the policies of the sub-MDPs 112. For example, if each policy from two or more sub-MDPs 112 has 10 actions, the average module 302 averages all 10 actions individually so that the a_1 actions are averaged, the a_2 actions are averaged, the a_3 actions are averaged, etc. to form a set of 10 averaged resultant actions of a resultant policy 116. One of skill in the art will recognize other ways for the average module 302 to average actions of the policies of the sub-MDPs 112.

The apparatus 300, in some embodiments, includes a voting module 304 configured to use majority voting for at least a portion of the actions of the policies of the two or more sub-MDPs 112. The voting module 304, in some embodiments, determines values for an action of each of the sub-MDPs 112 and then uses a majority voting scheme to determine which value to use for a resultant policy 116. While the example above in the discussion of the aggregation module 203 includes binary actions (e.g., O's and 1's), the voting module 304, in other embodiments, is applicable to actions with more than two bins. For example, where five sub-MDPs 112 are used and an action a_21 includes three bins of low, middle, and high, the values action a_21 for the five policies of the sub-MDPs 112 may be “low.” “middle.” “high,” “middle,” and “middle.” The voting module 304 determines that the winner of majority voting for action a_21 is “middle.” The aggregation module 208 then uses a value of “middle” for a_21 in a resultant policy.

In other embodiments, the voting module 304 uses a tie breaker criteria for deciding which action value to use when there is a tie. In the example above, if the five policies have an action a_21 with values of low, middle, high, middle, high, then a tie breaker is needed because there are two “middle” values and two “high” values are in a tie. In one embodiment, the tie breaker criteria for a tie of “middle” and “high” is to select “middle” for a first time a_21 is a middle/high tie and then to alternate between “middle and “high” for each subsequent tie. In other embodiments, other tie breaking schemes may be used. Once the voting module 304 determines a value to use for each action, the aggregation module 208 creates a resultant policy.

In some embodiments, the apparatus 300 includes an outlier module 306 configured to remove the actions of a sub-MDP (e.g., 112a) of the two or more sub-MDPs 112 in response to determining that the expected reward of the removed sub-MDP 112a is an outlier with respect to the expected rewards of other sub-MDPs (e.g., 112b-n) of the two or more sub-MDPs 112. In some embodiments, the outlier module 306 uses a statistical method for determining whether or not the expected reward of a sub-MDP 112a is an outlier.

In one embodiment, the outlier module 306 determines that the expected reward of a possible outlier sub-MDP 112a is more than 1.5 times the interquartile range of the other expected rewards of the other sub-MDPs 112b-n below the first quartile or above the third quartile to be considered an outlier. In other embodiments, the outlier module 306 determines that the expected reward is more than a percentage amount above or below a mean of the other expected rewards of the other sub-MDPs 112b-n. One of skill in the art will recognize other ways to identify an expected reward that is an outlier with respect to other expected rewards of the other sub-MDPs 112b-n. Once the outlier module 306 determines that an expected reward of a sub-MDP 112a is an outlier, the aggregation module 208 removes the outlier sub-MDP 112a before aggregating actions of the other sub-MDPs 112b-n.

In some embodiments, the apparatus 300 includes an ordering module 308 configured to order the state variables of the set of state variables S prior to creating the two or more sub-MDPs 112 according to a state importance criteria. In some embodiments, the ordering module 308 sorts columns of an input data set 104 based on the state importance criteria. In some embodiments, the state importance criteria includes various importance criteria, such as an amount of influence a state has on actions, a level of criticality of various states with respect to the problem/process 106, based on importance classification for each state variable, or the like.

In some embodiments, the apparatus 300 includes a binning module 310 configured to convert raw data from an input data set 104 into a plurality of discrete values. In one embodiment, the binning module 310 creates a number of bins for a state variable and for an action. Where the number of bins is three for a range of values from a voltage range of three volts, in some embodiments, the 3-volt range may be divided into ranges of 0-1 volt (“V”), 1.001 to 2 V, 2.001 to 3 V, which may be called low, medium, and high with values of 0.5 V. 1.5 V and 2.5 V. Other embodiments include different number of bins for a state or action variables. In some embodiments, states of a sub-MDP 112 each have the same bins. In other embodiments, states of sub-MDPs 112 do not all have the same number of bins for each state or action. One of skill in the art will recognize other binning strategies for sub-MDPs 112.

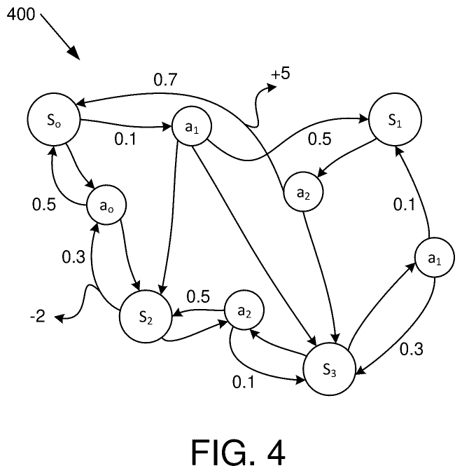

FIG. 4 is a diagram 400 of a simple MDP with four state variables and three actions, according to various embodiments. Each state is a larger circle with an “s” followed by a number. Each action is a smaller circle with an a and another number. The four state variables are S₀, S₁, S₂, and S₃. The action variables are a₀, a₁, and a₂. Arrows indicate state and action dependencies along with weighting, which is indicated by the numbers by the arrows. In some embodiments, a weighting represents a probability. For example, state S₁ (top right) is dependent on action a₁ with a weighting of 0.1. Arrows pointing out from other arrows indicate rewards. Other MDPs are more complicated and may be represented by equations, rules, etc. One of skill in the art will recognize other ways to represent an MDP.

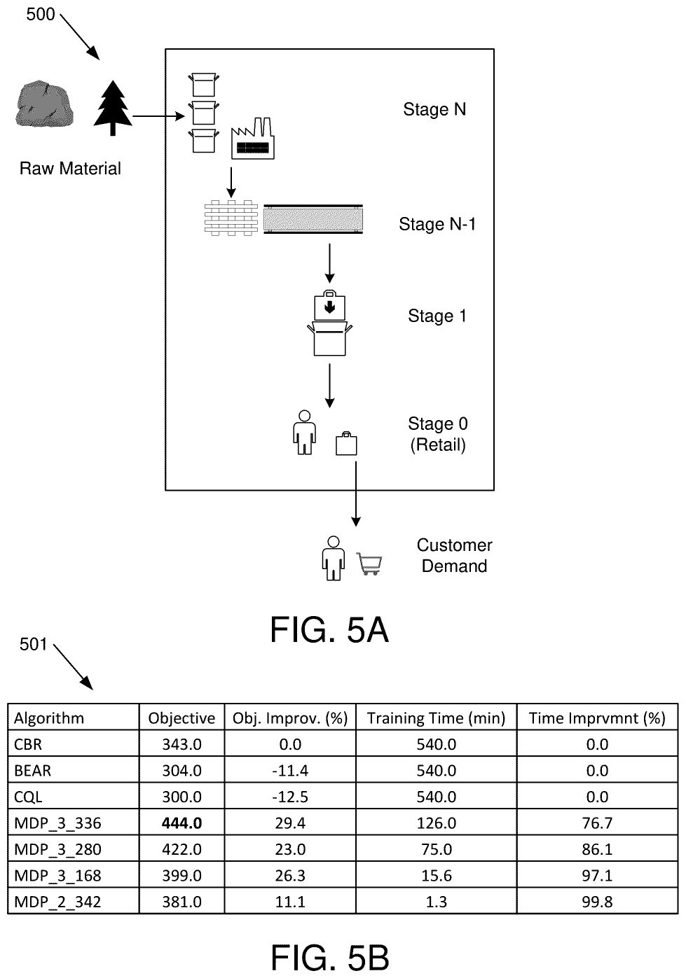

FIG. 5A is a schematic block diagram of an example manufacturing process 500 with M stages before reaching retail, according to various embodiments. The process receives unlimited resources, such as trees to be made into lumber. A first stage is represented by M, a second stage is represented by M−1, a third stage would be M−2, etc. down to a first stage 1 that is followed by stage 0, which is retail selling the product of the process. The simple manufacturing process 500 was simulated using different methods and MDPs with different amounts of state data (rows of a matrix) and different amounts of states.

FIG. 5B is a table 501 with simulation results for the manufacturing process of FIG. 5A for different algorithms, including MDPs of different sizes. A first reinforcement algorithms called Case Based Reasoning (“CBR”) has an objective score of 343 (e.g., opposite or reciprocal of expected cost) and a training time of 540 minutes. The second reinforcement algorithm Borrowing Energy with Adaptive Rewards (“BEAR”) has an objective score of 304, which is a −11% decrease, and again a training time of 540 minutes. The third reinforcement algorithm Conservative Q-Learning (“CQL”) has an objective score of 300, a −12% decrease, and again takes 540 minutes to process.

A first MDP, labeled MDP_3_336 (3 state variables and 336 states) has an objective score of 444, which is a 29.4% increase over CBR and execution takes 126.0 minutes, which is a 76.7% improvement over CBR, BEAR, and CQL. Other sized MDPs were also analyzed. A second MDP (3 states and 280 rows) labeled MDP_3_280 has an objective score of 422, which is a 23% increase over CBR and a quicker execution time of 75.0 minutes, which is an 86.1% improvement. A third MDP (3 state variables and 168 states) labeled MDP_3_168 has an objective score of 399, a 26.3% improvement over CBR with an execution time of 15.6 minutes, a 97.1% improvement. A final MDP (2 state variables and 342 states) labeled MDP_2_342 has an objective score of 381, only an 11.1% improvement over CBR, but has an execution time of 1.3 minutes, which is an improvement of 99.8%.

The MDPs, which could be sub-MDPs 112, show an improvement in the objective compared to CBR, BEAR, and CQL. The bigger the MDP, the better the objective, but the slower the MDP is to execute. Thus, there is a tradeoff between objective score and execution time. The MDP creation module 204, in some embodiments, selects a number of states per sub-MDP 112 based on the tradeoff between objective score and execution time.

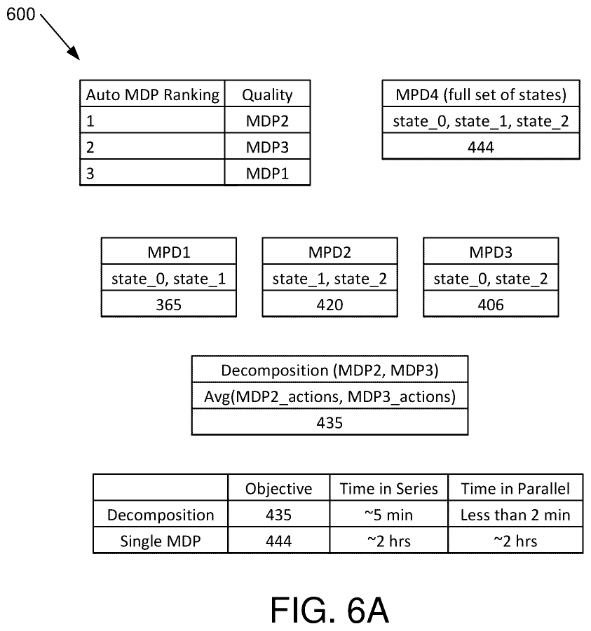

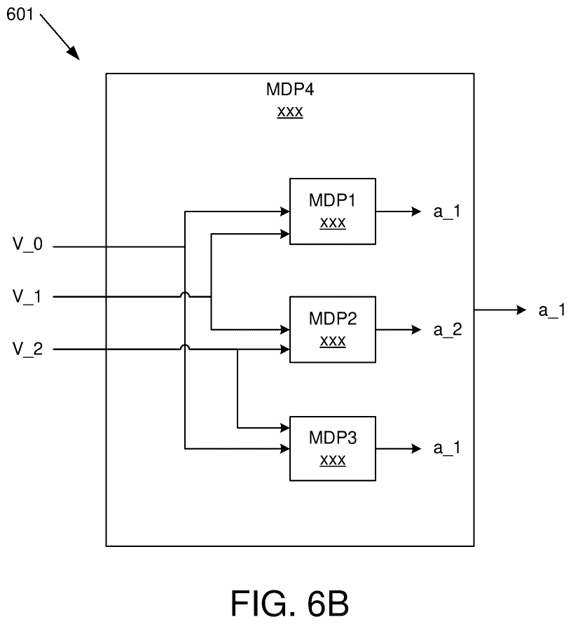

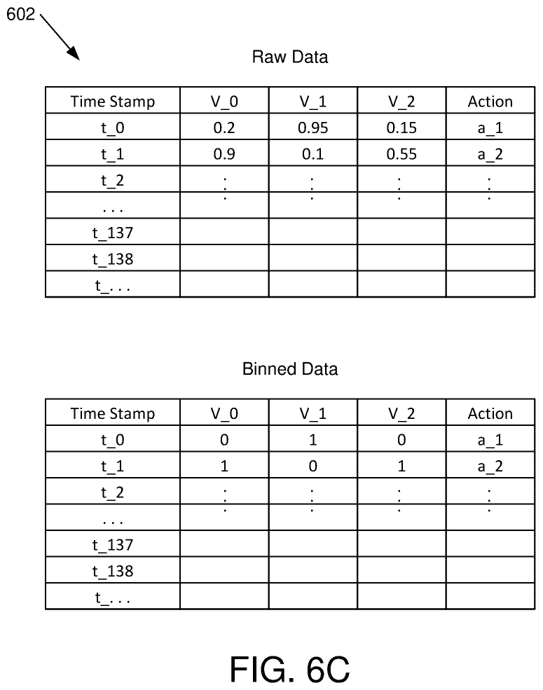

FIG. 6A is a diagram 600 depicting portions of an example of MDP decomposition and aggregation, according to various embodiments. In the example, a problem/process 106 is modeled with a simple model that could be formulated into a single large MDP labeled MDP4 that includes state_0, state_1, and state_2. An input data set 104 is used to create three smaller sub-MDPs: MDP1, MDP2, and MDP3. MDP1 is dependent on state_0 and state_1. MDP2 is dependent on state_1 and state_2. MDP3 is dependent on state_0 and state_2. MDP1, MDP2, and MDP3 are each executed and an objective or expected reward for MDP1 is 365, the expected reward for MDP2 is 420, and the expected reward for MDP3 406.

For comparison purposes, MDP4 was executed and the expected reward for MDP4 1 444. The expected reward for MDP2 and MDP3 are similar and are quite a bit higher than the expected reward of 365 for MDP1 so MDP1 is considered an outlier and is not used for aggregation. The actions of MDP2 and MDP3 are aggregated to produce a resultant policy for use in execution of the problem/process 106. Again, for comparison purposes, a decomposition MDP with the aggregated resultant policy was executed and the expected reward is 435, which is approaching the expected reward of 444 of the full MDP4. Comparing objectives (expected rewards) and execution time, the decomposition MDP (i.e., combined actions of MDP2 and MDP3) results in an expected reward of 435. The execution time for executing MDP2 and MDP3 in series is around 5 minutes. If MDP2 and MDP3 are executed in parallel, the execution time is less than 2 minutes. While the expected reward for the full MDP4 is 444, the execution timer is around 2 hours. Thus, while the expected reward is a little lower, the decrease in execution time makes use of the embodiments described herein for the MDP decomposition engine 102 worthwhile.

FIG. 6B is a schematic block diagram 601 depicting data flow for portions of the example of MDP decomposition and aggregation of FIG. 6A, according to various embodiments. The state_0, state_1, and state_2 of FIG. 6A correspond to analog states v_0, v_1, and v_2 with actual voltages of v_0=0.2 V. v_1=0.95 V, and v_2=0.15 V. Binning is applied to states v_0, v_1, and v_2 where low=0-0.5 V and high 0.5-1 V. There are two bins per each state variable: b_0=[0,0.5) and b_1=[0.5,1]. (Mathematically, b_0 includes up to, but not including 0.5 V.) The state space S for binned v_0, v_1, and v_2, where each could be either low or high, would have 2³=8 possible variations.

A policy is a mapping of the states to actions. Namely, for each one of 8 state possibilities there will some recommended action: π: s→a. Optimal policy is a policy that maps states to actions such that expected reward is maximized (equivalently expected cost is minimized). In some embodiment, there are two distinct operations that are useful with policies: computing and applying. Computing is computationally expensive for large scale MDPs. Problems/processes 106 with 1000 or more binary state variables will have a state space is 2\hat{ }1000, which is difficult to process. For applying a policy, it is good to have a solution that is computationally cheap for either single large MDP or several small MDPs or a “resultant” MDP.

Returning to the example of FIG. 6B, majority voting results in action a_1 being the winner. Action a_1, in some embodiments, represents a hardware related action, such as opening or closing a switch. In other embodiments, action a_1 causes something else to happen. Action a_1 in a typical policy would be one of many actions in a policy.

When formulating each sub-MDP 112 of MDP1, MDP2, and MDP3, a binning policy is applied to each state and action to limit each state and action to 2 bins, 3 bins, 4 bins, or whatever is appropriate for each state or action. In some embodiments, liner programming (“LP”) is used to formulate the sub-MDPs 112. In some embodiment, binned values of states are converted to analog voltages for use in the problem/process 106.

FIG. 6C is a diagram 602 depicting portions of an example of MDP decomposition and aggregation, according to various embodiments. The top table illustrates raw data in the form of voltages or other real numbers for the states. Each row represents a point in time. In some embodiments, the rows represent sequential state entries over time. For example, each entry could be 1 second apart. In other embodiments, the rows represent different times that are not sequential. The lower table represents the same raw data that has been “binned” and converted to discrete values appropriate for input to an MPD.

When using the input data set 104, not every possible state needs to be included. However, more samples provide additional information. Every row or sample corresponds to a state, which may be same state or a different state than other states in the table. At every state (row), actions are taken that transition the problem/process 106 to a next state. An input data set 104 may be used for MDP formulation and a single resultant policy that may then be used to solve a problem of the problem/process 106, to control a process of the problem/process 106, etc. The process may be an industrial control process or some other process large enough to have many states and actions that would produce a large MDP. In some embodiments, the input data set 104 is used for training to produce a resultant policy for operation. In other embodiments, the input data set 104 is used to derive a resultant policy that helps to solve a problem in an optimal or low cost way. One of skill in the art will recognize other ways to use an input data set 104 in an MDP decomposition engine 102 to produce a resultant policy. After the resultant policy is derived, the resultant policy may be used until a significant change in conditions, such as a plant input change, a hardware change, seasonal changes to a plant, reformulation of a problem, etc.

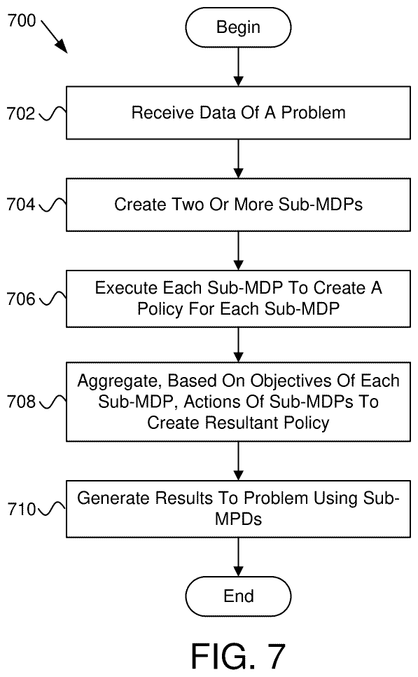

FIG. 7 is a schematic flow chart diagram illustrating one embodiment of a method 700 for MDP decomposition and aggregation, according to various embodiments. The method 700 begins and receives 702 data elements for a problem/process 106. The data elements include a finite set of state variables S where each state variable s of the set of state variables S includes state entries. Each state entry representing a state. The data elements include a finite set of actions. The problem is to be formulated using a Markov Decision Process (“MDP”). The method 700 creates 704 two or more sub-MDPs 112. Each sub-MDP 112 includes a portion of the set of state variables S and the set of actions. Each sub-MDP 112 includes less than the set of state variables S in an MDP of a complete set of the set of state variables S. Each sub-MDP 112 includes a same reward function.

The method 700 executes 706, using at least one processor 212, each sub-MDP 112. Results of execution of a sub-MDP 112 of the two or more sub-MDPs 112 includes a policy and an expected reward from the reward function. The policy of the sub-MDP 112 maps states of the sub-MDP 112 to the actions. The method 700 aggregates 708, based on the expected rewards of the results, the actions of the sub-MDPs 112 to create a resultant policy with a set of resultant actions. The method 700 generates 710, using at least one processor 212 and using state entries for the set of state variables, results to the problem/process 106 based on the resultant policy, and the method 700 ends. In various embodiments, all or a portion of the method 700 is implemented using the data module 202, the MDP creation module 204, the MDP execution module 206, the aggregation module 208, the policy application module 210, the search formulation 110, and/or the aggregator 114.

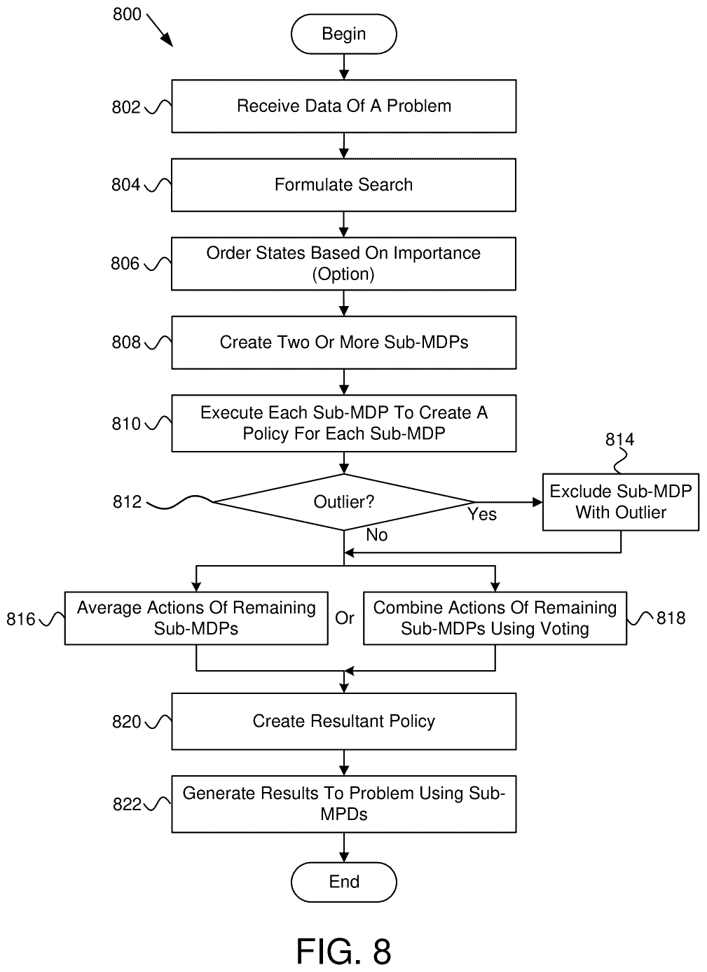

FIG. 8 is a schematic flow chart diagram illustrating one embodiment of another method 800 for MDP decomposition and aggregation, according to various embodiments. The method 800 begins and receives 802 an input data set 104 of a problem/process 106. The method 800 formulates 804 a search, for example, using linear programming, dynamic programming, etc. The method 800, in some embodiments, orders 806 the state variables of the set of state variables S according to a state importance criteria.

The method 800 creates 808 two or more sub-MDPs 112. Each sub-MDP 112 includes a portion of the set of state variables S and the set of actions. Each sub-MDP 112 includes less than the set of state variables S in an MDP of a complete set of the set of state variables S. Each sub-MDP 112 includes a same reward function. The method 800 executes 810, using at least one processor 212, each sub-MDP 112. Results of execution of a sub-MDP 112 of the two or more sub-MDPs 112 includes a policy and an expected reward from the reward function. The policy of the sub-MDP 112 maps states of the sub-MDP 112 to the actions.

The method 800 determines 812 if an expected reward of a sub-MDP (e.g., 112a) is an outlier with respect to the expected rewards of other sub-MDPs 112b-n of the two or more sub-MDPs 112. If the method 800 determines 812 that the expected reward of a sub-MDP 112a is an outlier, the method 800 excludes 814 the sub-MDP 112a from aggregation and proceeds with averaging 816/voting 818. If the method 800 determines 812 that an expected reward of a sub-MDP 112 is not an outlier, the method 800 proceeds with averaging 816/voting 818.

In some embodiments, the method 800 averages 816 at least a portion of the policies of two or more of the two or more sub-MDPs 112. In some embodiments, the method 800 averages 816 at least a portion of the actions of the policies of sub-MDPs 112 that are being aggregated (e.g., excluding outliers). In other embodiments, the method 800 combines 818 actions of sub-MDPs 112 that are being aggregated (e.g., excluding outliers) using majority voting. The method 800 creates 820 a resultant policy using results of averaging 816 and/or voting 818. The method 800 generates 822, using at least one processor 212 and using state entries for the set of state variables, results to the problem/process 106 based on the resultant policy, and the method 800 ends. In various embodiments, all or a portion of the method 800 is implemented using the data module 202, the MDP creation module 204, the MDP execution module 206, the aggregation module 208, the policy application module 210, the average module 302, the voting module 304, the outlier module 306, the ordering module 308, the binning module 310, the search formulation 110, and/or the aggregator 114.

FIG. 9 is a schematic block diagram of a computing environment 900 for execution of MDP decomposition and aggregation. Computing environment 900 contains an example of an environment for the execution of at least some of the computer code involved in performing the inventive methods, such as MDP decomposition engine 102. In addition to MDP decomposition engine 102, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and the MDP decomposition engine 102, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in MDP decomposition engine 102 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid-state storage devices. Operating system 922 may take several forms, such as various known proprietary operating systems or open source Portable Operating System Interface-type operating systems that employ a kernel. The code included in MDP decomposition engine 102 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving data elements for a problem, wherein the data elements comprise finite state data for a set of state variables and a finite set of actions, a portion of the state data corresponding to each of the set of state variables representing a state, and wherein the problem is to be formulated using a Markov Decision Process (“MDP”);
creating two or more sub-MDPs, each sub-MDP comprising a portion of the set of state variables and the set of actions, wherein each sub-MDP comprises less than the set of state variables in an MDP with a complete set of the set of state variables, and wherein each sub-MDP comprises a same reward function;
executing, using at least one processor, each sub-MDP, wherein results of execution of a sub-MDP of the two or more sub-MDPs comprises a policy and an expected reward from the reward function, the policy of the sub-MDP maps states of the sub-MDP to actions;
aggregating, based on the expected rewards of the results, the actions of the policies of the sub-MDPs to create a resultant policy comprising a set of resultant actions; and
generating, using at least one processor and using state entries for the set of state variables, results to the problem based on the resultant policy.

2. The computer-implemented method of claim 1, wherein aggregating the policies of the sub-MDPs comprises:
averaging at least a portion of the policies of two or more of the two or more sub-MDPs; and/or
using majority voting for at least a portion of the actions of the policies of the two or more sub-MDPs.

3. The computer-implemented method of claim 1, wherein aggregating the actions of the sub-MDPs comprises:
determining that the expected reward of a sub-MDP of the two or more sub-MDPs is an outlier with respect to the expected rewards of other sub-MDPs of the two or more sub-MDPs; and
excluding the sub-MDP with the expected reward determined to be an outlier from aggregation of the actions of the sub-MDPs.

4. The computer-implemented method of claim 1, wherein the method further comprises ordering the state variables of the set of state variables prior to creating the two or more sub-MDPs according to a state importance criteria.

5. The computer-implemented method of claim 1, wherein a combination of the set of state variables of each of the two or more sub-MDPs equals the state variables of the set of state variables of the data elements.

6. The computer-implemented method of claim 1, wherein each sub-MDP comprises a transition probabilities matrix determining transition probabilities between states of the sub-MDP once actions of the set of actions of the sub-MDP are performed.

7. The computer-implemented method of claim 1, wherein the expected reward of a sub-MDP of the two or more sub-MDPs is determined for a pair of a state of the sub-MDP and an action of the set of actions of the sub-MDP.

8. The computer-implemented method of claim 1, further comprising determining a binning strategy for each state variable and each action, wherein a binning strategy for a state variable comprises constraining the state variable to one of a limited number of possible values and a binning strategy for an action comprises constraining the action to one of a limited number of possible values.

9. The computer-implemented method of claim 1, wherein the problem comprises:
a controls process comprising a controller wherein the resultant set of actions is implemented in the controller;
a manufacturing process comprising optimization of the manufacturing process; and/or
a queueing system.

10. An apparatus comprising:
at least one processor; and
non-transitory computer readable storage media storing code, the code being executable by the processor to perform operations comprising:
receiving data elements for a problem, wherein the data elements comprise finite state data for a set of state variables and a finite set of actions, a portion of the state data corresponding to each of the set of state variables representing a state, and wherein the problem is to be formulated using a Markov Decision Process (“MDP”);
creating two or more sub-MDPs, each sub-MDP comprising a portion of the set of state variables and the set of actions, wherein each sub-MDP comprises less than the set of state variables in an MDP with a complete set of the set of state variables, and wherein each sub-MDP comprises a same reward function;
executing, using at least one processor, each sub-MDP, wherein results of execution of a sub-MDP of the two or more sub-MDPs comprises a policy and an expected reward from the reward function, the policy of the sub-MDP maps states of the sub-MDP to actions;
aggregating, based on the expected rewards of the results, the actions of the policies of the sub-MDPs to create a resultant policy comprising a set of resultant actions; and
generating, using at least one processor and using state entries for the set of state variables, results to the problem based on the resultant policy.

11. The apparatus of claim 10, wherein aggregating the policies of the sub-MDPs comprises:
averaging at least a portion of the policies of two or more of the two or more sub-MDPs; and/or
using majority voting for at least a portion of the actions of the policies of the two or more sub-MDPs.

12. The apparatus of claim 10, wherein aggregating the actions of the sub-MDPs comprises:
determining that the expected reward of a sub-MDP of the two or more sub-MDPs is an outlier with respect to the expected rewards of other sub-MDPs of the two or more sub-MDPs; and
excluding the sub-MDP with the expected reward determined to be an outlier from aggregation of the actions of the sub-MDPs.

13. The apparatus of claim 10, wherein the operations further comprise ordering the state variables of the set of state variables prior to creating the two or more sub-MDPs according to a state importance criteria.

14. The apparatus of claim 10, wherein a combination of the set of state variables of each of the two or more sub-MDPs equals the state variables of the set of state variables of the data elements.

15. The apparatus of claim 10, wherein each sub-MDP comprises a transition probabilities matrix determining transition probabilities between state variables of the set of states of the sub-MDP once actions of the set of actions of the sub-MDP are performed.

16. The apparatus of claim 10, wherein the expected reward of a sub-MDP of the two or more sub-MDPs is determined for a pair of a state variable of the set of state variables of the sub-MDP and an action of the set of actions of the sub-MDP.

17. The apparatus of claim 10, further comprising determining a binning strategy for each state variable and each action, wherein a binning strategy for a state variable comprises constraining the state variable to one of a limited number of possible values and a binning strategy for an action comprises constraining the action to one of a limited number of possible values.

18. The apparatus of claim 10, wherein the problem comprises:
a controls process comprising a controller wherein the resultant set of actions is implemented in the controller;
a manufacturing process comprising optimization of the manufacturing process; and/or
a queueing system.

19. A computer program product comprising a computer readable storage medium having program instructions embodied therewith, the program instructions executable by a processor to cause the processor to perform operations comprising:
receiving data elements for a problem, wherein the data elements comprise finite state data for a set of state variables and a finite set of actions, a portion of the state data corresponding to each of the set of state variables representing a state, and wherein the problem is to be formulated using a Markov Decision Process (“MDP”);
creating two or more sub-MDPs, each sub-MDP comprising a portion of the set of state variables and the set of actions, wherein each sub-MDP comprises less than the set of state variables in an MDP with a complete set of the set of state variables, and wherein each sub-MDP comprises a same reward function;
executing, using at least one processor, each sub-MDP, wherein results of execution of a sub-MDP of the two or more sub-MDPs comprises a policy and an expected reward from the reward function, the policy of the sub-MDP maps states of the sub-MDP to actions;
aggregating, based on the expected rewards of the results, the actions of policies of the sub-MDPs to create a resultant policy comprising a set of resultant actions; and
generating, using at least one processor and using state entries for the set of state variables, results to the problem based on the resultant policy.

20. The computer program product of claim 19, wherein aggregating the policies of the sub-MDPs comprises:
averaging at least a portion of the policies of two or more of the two or more sub-MDPs; and/or
using majority voting for at least a portion of the actions of the policies of the two or more sub-MDPs.
